(19) United States
(12) Patent Application Publication
(10) Pub. No.: US 2016/0129949 A1
(43) Pub. Date: May 12, 2016

(54) MODULAR TRUCK BOX COMPARTMENT STRUCTURE

(71) Applicants: Jason Marable, St. Clair Shores, MI (US); Trevor Garvey, Algonac, MI (US)

(72) Inventors: Jason Marable, St. Clair Shores, MI (US); Trevor Garvey, Algonac, MI (US)

(21) Appl. No.: 14/536,746

(22) Filed: Nov. 10, 2014

(51) Int. Cl. B62D 33/02; B60R 9/06

(52) U.S. Cl. CPC B62D 33/02; B60R 9/06

(57) ABSTRACT

A vehicle may include an occupant cabin, a cargo compartment and a plurality of panels. The cargo compartment is separated from the occupant cabin and includes a floor and a pair of sidewalls extending vertically upward from the floor. The sidewalls extend between the occupant cabin and an aft end of the vehicle. The sidewalls are parallel to each other and may include a plurality of vertically extending slots and a plurality of horizontally extending slots. The plurality of panels are configured to be received in any of the vertically and horizontally extending slots and define one or more sub-compartments within the cargo compartment.

### FIELD

The present disclosure relates to a modular truck box compartment structure.

### BACKGROUND

Many modern vehicles include a cargo compartment or area that is separate from an occupant compartment or area. For example, sport-utility-vehicles often include a cargo area behind a rear row of seat, coupes and sedans often include a trunk acting as a cargo area. Pickup trucks typically include a cargo compartment or bed that is separated from the occupant compartment by a wall and a window. Cargo placed in the cargo area or compartment by a user can move, shift and/or fall over while the vehicle is in motion, which can cause damage to the cargo and/or to the vehicle. Furthermore, such movement of the cargo during transit can make it difficult to maintain organization of the cargo and/or maintain an orderly arrangement of the cargo within the cargo area or compartment.

### SUMMARY

The present disclosure provides a vehicle that may include an occupant cabin, a cargo compartment and a plurality of panels. The cargo compartment is separated from the occupant cabin and includes a floor and a pair of sidewalls extending vertically upward from the floor. The sidewalls extend between the occupant cabin and an aft end of the vehicle. The sidewalls are parallel to each other and may include a plurality of vertically extending slots and a plurality of horizontally extending slots. The plurality of panels are configured to be received in any of the vertically and horizontally extending slots and define one or more sub-compartments within the cargo compartment.

In some configurations, all of the panels are identical to each other.

In some configurations, each of the panels includes a first edge having a tab extending therefrom and a second edge having a groove formed therein such that the tab of one of the panels can engage the groove of a directly adjacent panel to removably fix the panels relative to each other.

In some configurations, a length of each panel is sized such that a single panel extends from one of the sidewalls to the other sidewall.

In some configurations, a width of each panel is sized such that each vertical slot can receive two panels stacked one atop the other.

In some configurations, each of the sidewalls include a pair of the horizontally extending slots, the horizontally extending slots are spaced apart from each other and parallel to each other and the floor such that one or more panels received in one of the horizontally extending slots of each sidewall defines a lower sub-compartment defined by the floor and an upper sub-compartment spaced apart from the floor.

In some configurations, each sidewall includes a storage slot disposed between the occupant cabin and the vertically extending slot closest to the occupant cabin.

In some configurations, the storage slot extends parallel to the vertically extending slots and has a width greater than or equal to the thickness of at least two of the panels stacked against each other.

In some configurations, the storage slot has a height greater than or equal to a height of two panels stacked on atop the other.

In some configurations, the storage slot in one sidewall is aligned with the storage slot in the other sidewall so that at least four of the panels can be simultaneously received in the storage slots of both sidewalls.

In some configurations, an upper one of horizontal slots in each sidewall is disposed proximate an upper edge of the sidewall such that the upper horizontal slots are configured to receive some of the panels in a manner that the panels cooperate to form a tonneau cover.

In another form, the present disclosure provides a vehicle that may include an occupant cabin, a cargo compartment and a plurality of panels. The cargo compartment is separated from the occupant cabin and includes a floor, a pair of sidewalls and a tailgate. The sidewalls extend vertically upward from the floor and extend between the occupant cabin and the tailgate. The sidewalls are parallel to each other and may each include a plurality of vertically extending slots and a horizontally extending slot. The plurality of panels may all be identical to each other and are configured to be received in any of the vertically and horizontally extending slots and define one or more sub-compartments within the cargo compartment.

In some configurations, each of the panels includes a first edge having a tab extending therefrom and a second edge having a groove formed therein such that the tab of one of the panels can engage the groove of a directly adjacent panel to removably fix the panels relative to each other.

In some configurations, a length of each panel is sized such that a single panel extends from one of the sidewalls to the other sidewall.

In some configurations, a width of each panel is sized such that each vertical slot can receive two panels stacked one atop the other.

In some configurations, each of the sidewalls include a pair of the horizontally extending slots, the horizontally extending slots are spaced apart from each other and parallel to each other and the floor such that one or more panels received in one of the horizontally extending slots of each sidewall defines a lower sub-compartment defined by the floor and an upper sub-compartment spaced apart from the floor.

In some configurations, an upper one of horizontal slots in each sidewall is disposed proximate an upper edge of the sidewall such that the upper horizontal slots are configured to receive some of the panels in a manner that the panels cooperate to form a tonneau cover.

In some configurations, each sidewall includes a storage slot disposed between the occupant cabin and the vertically extending slot closest to the occupant cabin.

In some configurations, the storage slot extends parallel to the vertically extending slots and has a width greater than or equal to the thickness of at least two of the panels stacked against each other.

In some configurations, the storage slot has a height greater than or equal to a height of two panels stacked on atop the other.

In some configurations, the storage slot in one sidewall is aligned with the storage slot in the other sidewall so that at least four of the panels can be simultaneously received in the storage slots of both sidewalls.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a partial perspective view of a vehicle having a cargo compartment according to the principles of the present disclosure;

FIG. 2 is a partial perspective view of the vehicle having a plurality of panels installed in the cargo compartment in an exemplary configuration according to the principles of the present disclosure;

FIG. 3 is a partial perspective view of the vehicle with plurality of panels installed in the cargo compartment in another exemplary configuration according to the principles of the present disclosure;

FIG. 4 is a partial cross-sectional view of the cargo compartment with panels installed in the cargo compartment in another exemplary configuration;

FIG. 5 is a cross-sectioned perspective view of one of the panels;

FIG. 6 is another cross-sectioned perspective view of the panel;

FIG. 7 is another partial perspective view of the vehicle with panels in another exemplary configuration;

FIG. 8 is another partial perspective view of the vehicle with panels arranged in another exemplary configuration; and

FIG. 9 is another partial perspective view of the vehicle with panels arranged in a storage configuration.

### DETAILED DESCRIPTION

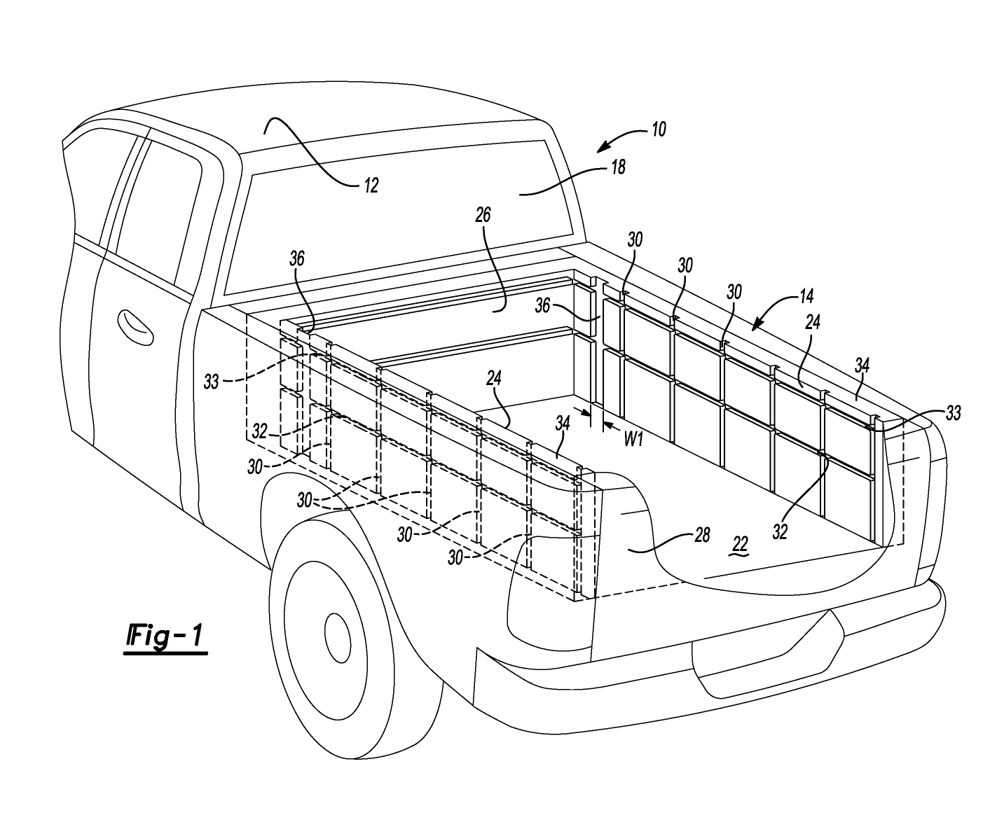

In an exemplary embodiment and with reference to FIGS. 1-9, a vehicle 10 is provided that includes an occupant cabin or cab 12, a cargo compartment or bed 14 and a plurality of panels 16. The occupant cabin 12 may be an enclosed compartment in which a driver and one or more passengers of the vehicle 10 may sit while the vehicle 10 is being driven. The cargo compartment 14 can be an enclosed or unenclosed compartment disposed behind the occupant cabin 12 and separated from the occupant cabin 12 by a window 18 and/or wall. As will be described in more detail below, the panels 16 and cargo compartment 14 cooperate to define a modular cargo storage system for the vehicle 10. One or more of the panels 16 can be positioned within the cargo compartment 14 in any of a variety of different configurations to define one or more sub-compartments 20 within the cargo compartment 14. In this manner, a user can place different items in different sub-compartments 20 to separate the items from each other and/or restrict or prevent excessive movement of one or more items within the cargo compartment 14 while the vehicle 10 is in motion. While the vehicle 10 shown in the figures is a pickup truck, the principles of the present disclosure may be applicable to other types of vehicles, such as sport-utility-vehicles, sedans, coupes, hatchbacks, or any other vehicle with a cargo compartment, cargo area, or trunk.

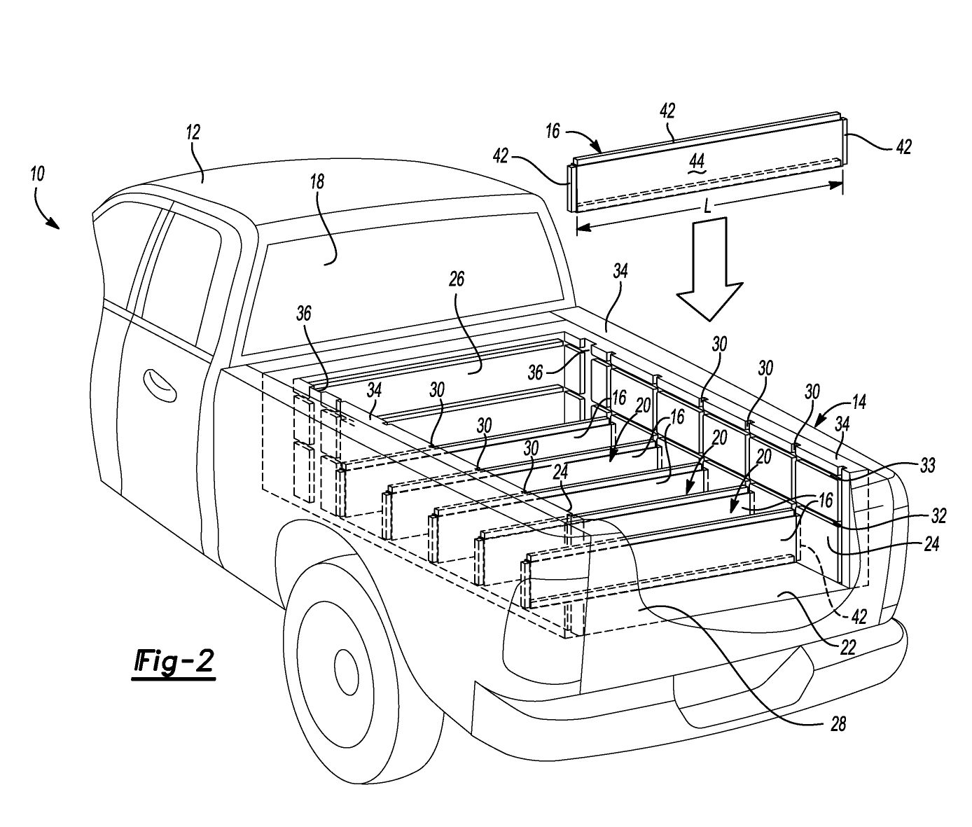

The cargo compartment 14 includes a floor 22, a pair of sidewalls 24, a front wall 26 and a rear tailgate 28. The front wall 26 and the window 18 can separate the cargo compartment 14 from the occupant cabin 12. The tailgate 28 may be pivotably mounted to the floor 22, for example. The sidewalls 24 may extend upward from the floor 22 and extend from the front wall 26 to the rear tailgate 28. Each sidewall 24 may include a plurality of vertical slots 30, a lower horizontal slot 32 and an upper horizontal slot 33. The vertical slots 30 are substantially parallel to each other and extend vertically from the floor 22 (or a location proximate the floor 22) through an upper edge 34 of the sidewalls 24. The vertical slots 30 of one of the sidewalls 24 are aligned with corresponding vertical slots 30 of the other sidewall 24 such that the panels 16 can be simultaneously received in vertical slots 30 of both sidewalls 24 while being positioned parallel to the front wall 26, as shown in FIG. 2.

The upper horizontal slot 33 in each sidewall 24 can be disposed proximate to the upper edge 34 of the sidewall 24. The lower horizontal slot 32 of each sidewall 24 can be disposed approximately midway between the upper horizontal slot 33 and the floor 22. The horizontal slots 32, 33 of one of the sidewalls 24 are aligned with corresponding horizontal slots 32, 33 of the other sidewall 24 such that the panels 16 can be simultaneously received in either the lower horizontal slots 32 or in the upper horizontal slots 33 of both sidewalls 24 while being positioned parallel to the floor 22, as shown in FIG. 3, for example.

Each of the sidewalls 24 may also include one or more storage recesses or slots 36. As shown in FIG. 1, the storage slots 36 may be disposed between the front wall 26 and the vertical slots 30 closest to the front wall 26. In some configurations, additional storage slots 36 could be disposed elsewhere. In some configurations, the storage slots 36 can be disposed adjacent the front wall 26. In some configurations, the front wall 26 may at least partially define the storage slots 36. The storage slots 36 can extend vertically from the floor 22 to the upper edges 34 of the sidewalls 24 and can be parallel to the vertical slots 30.

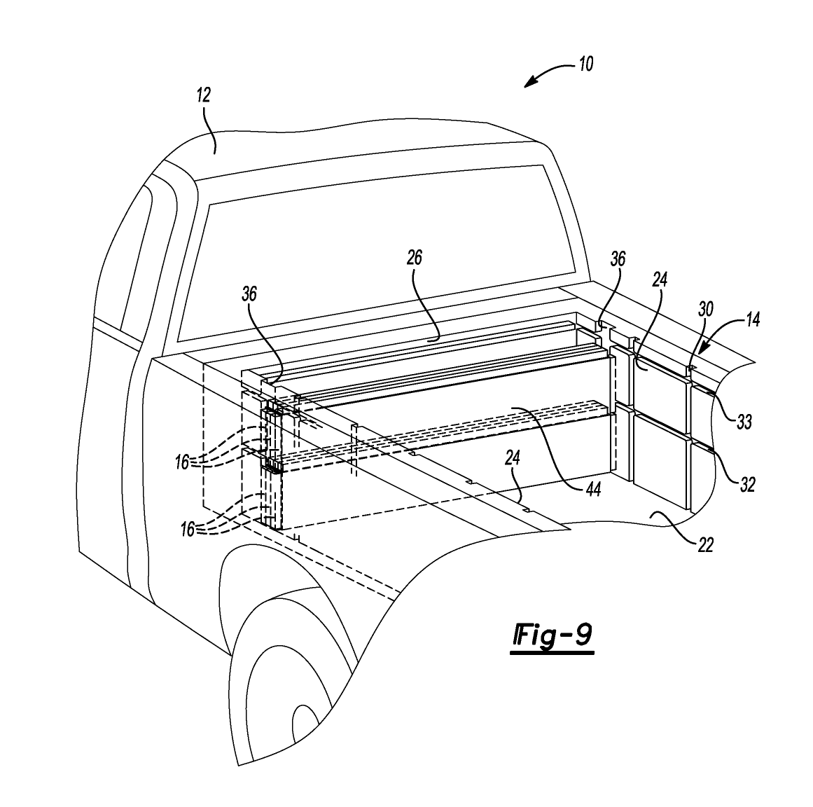

As shown in FIG. 9, the storage slots 36 are wider than the vertical slots 30 so that multiple panels 16 can be received and stored in the storage slots 36 below the lower horizontal slots 32 at the same time, and multiple panels 16 can also be received in the storage slots 36 above the lower horizontal slots 32 at the same time. That is, a width W1 of the storage slots 36 can be equal to or greater than at least two times a thickness T of one panel 16 (where the thickness T is defined as the distance between the two largest faces 44) of the panel 16). In this manner, at least two panels can be stacked against each other (i.e., stacked so that the largest faces 44 of the panels 16 are abutting each other) and received in the storage slots 36 below the lower horizontal slot 32. At least an additional two panels 16 could also be received in the storage slots 36 on top of the at least two other panels 16 received in the storage slots 36. In this manner, at least four panels 16 could be stored in the storage slots 36 simultaneously. It will be appreciated that the width of the storage slots 36 could be sized to receive any number of panels 16 at the same time. For example, in the configuration shown in FIG. 9, the storage slots 36 are sized to receive three panels 16 below the lower horizontal slots 32 and three more panels 16 stacked above the lower horizontal slots 32.

The panels 16 can be generally flat elongated boards formed from a polymeric material, wood and/or metal, for example. Each panel 16 includes a main body 40 and a plurality of tabs or tongues 42. The two largest faces 44 of the main body 40 are parallel to each other and have a length L and a width W2. The length L of the main body 40 can be approximately equal to the distance between the sidewalls 24. The width W2 of the main body 40 can be less than or equal to the distance between the floor 22 and the lower horizontal slot 32 and/or less than or equal to the distance between the lower and upper horizontal slots 32, 33.

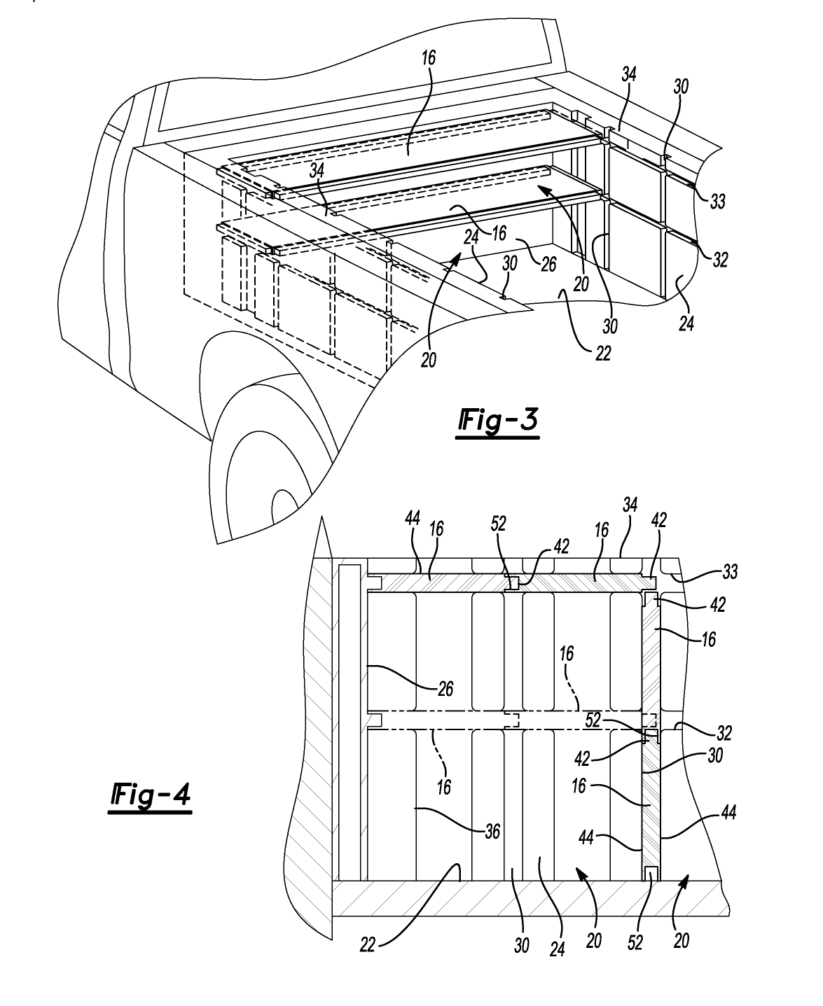

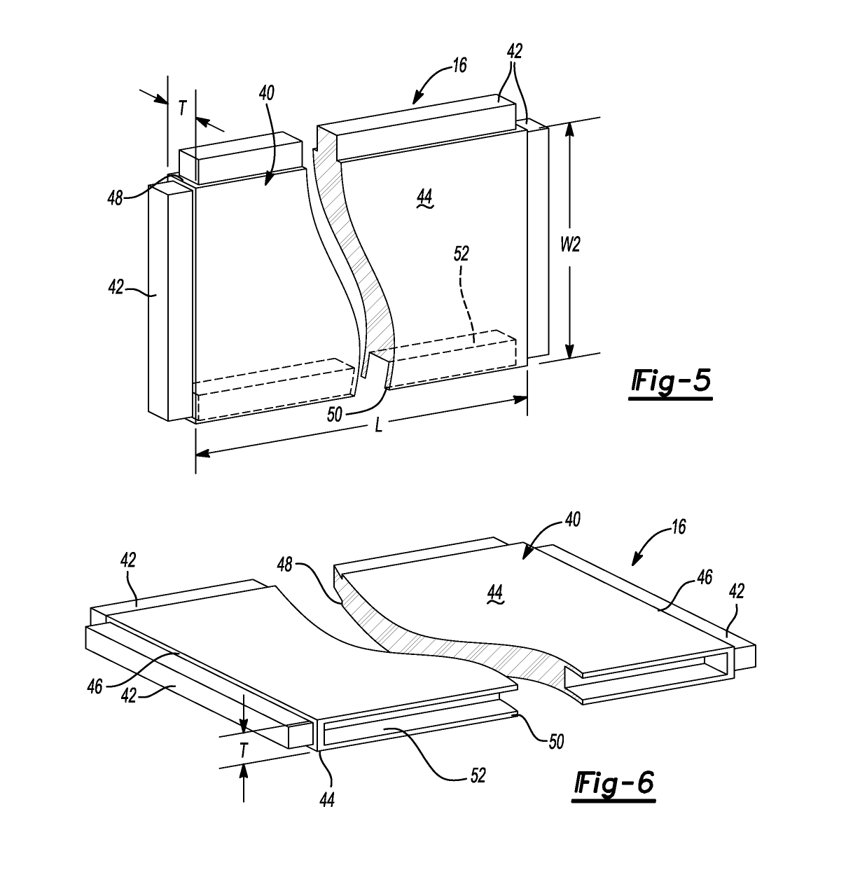

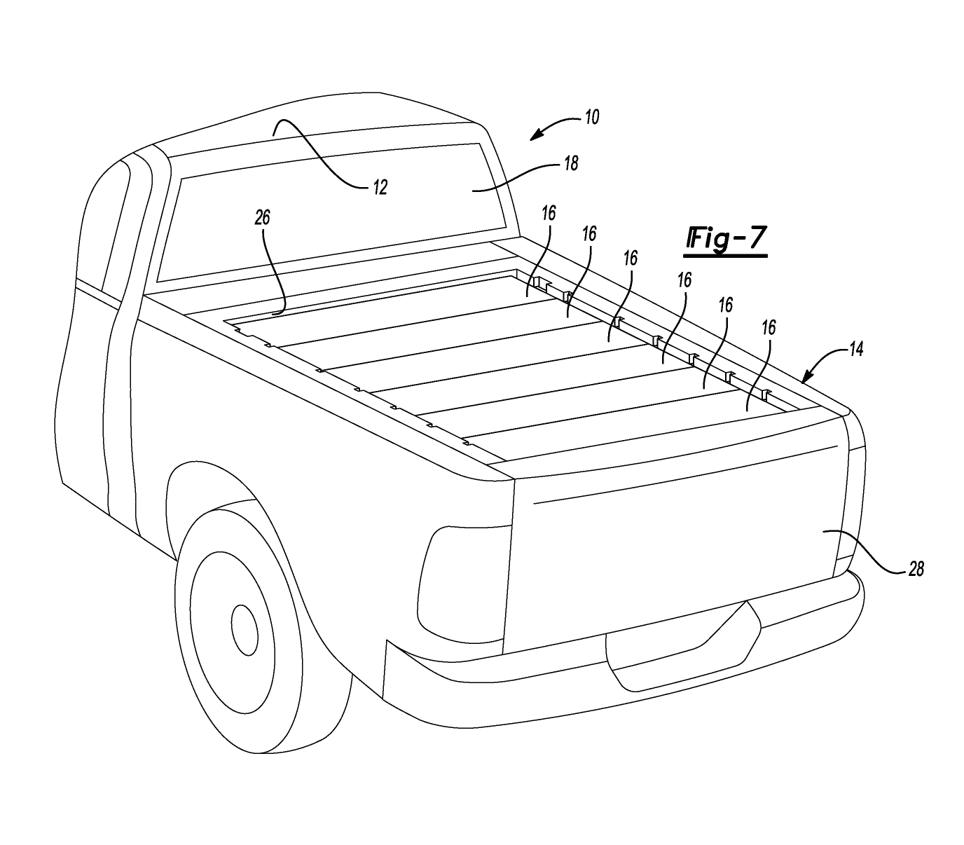

As shown in FIGS. 5 and 6, the tabs 42 may extend outward from opposing ends 46 of the main body 40 and from a first longitudinal edge 48 of the main body 40. A second longitudinal edge 50 (opposite the first longitudinal edge 48) of the main body 40 may include a groove 52 (FIGS. 5 and 6) sized to receive the tab 42 of the first longitudinal edge 48 of an adjacent panel 16, as shown in FIG. 4. In this manner, adjacent panels 16 can be secured to each other by tongue-and-groove engagement. The tabs 42 on the opposing ends 46 can be received in corresponding vertical slots 30 in the sidewalls 24 (as shown in FIG. 2) or in the lower or upper horizontal slots 32, 33 in the sidewalls 24 (as shown in FIGS. 3, 7 and 8). In the example provided in the figures, all of the panels 16 are identical to each other. In some configurations, panels 16 of differing shapes and sizes could be employed.

The cargo compartment 14 and panels 16 form a modular cargo storage system for the vehicle 10. As described above, one or more of the panels 16 can be positioned within the cargo compartment 14 in any of a variety of different configurations to define one or more sub-compartments 20 within the cargo compartment 14. The user can insert a desired number of panels 16 into a desired set of slots 30, 32, 33 to create sub-compartments 20 of desired sizes in desired positions. Depending on the user's desired configuration of sub-compartments 20, each vertical slot 30 can receive zero, one or two panels 16 (in some embodiments, the panels 16 can be sized so that each vertical slot 30 can receive more than two panels 16), the lower horizontal slots 32 can receive zero, one or a plurality of panels 16, and/or the upper horizontal slots 33 can receive zero, one or a plurality of panels 16.

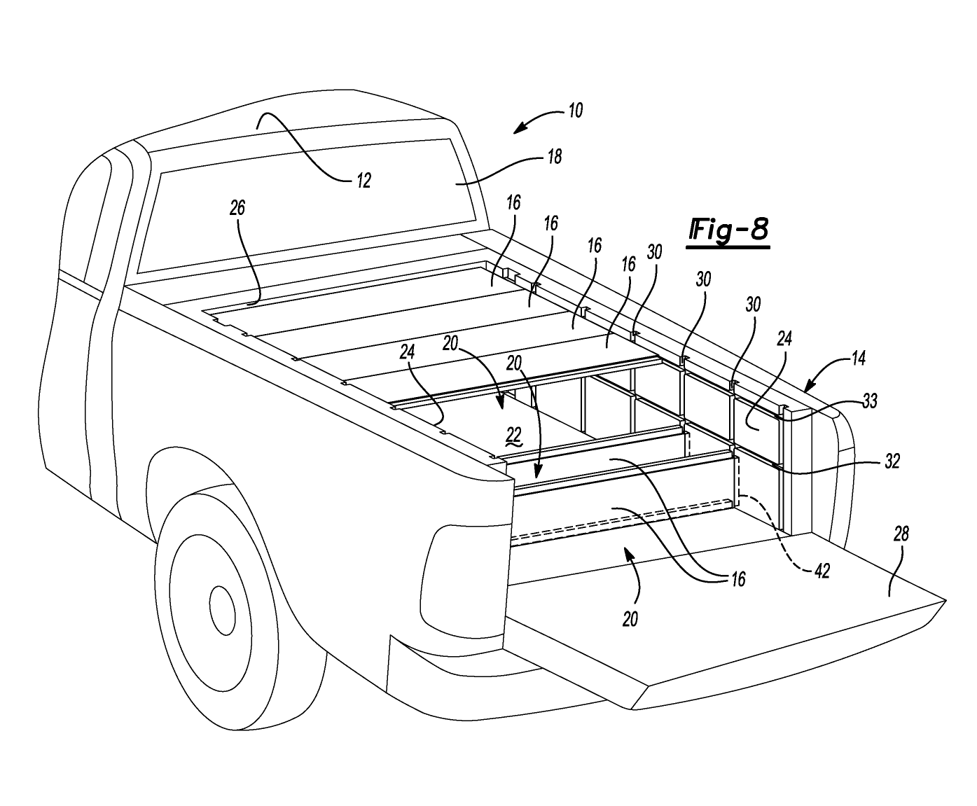

For example, the configuration shown in FIG. 2 includes a plurality of sub-compartments 20 defined by the floor 22 and a pair of adjacent panels 16; one sub-compartment 20 defined by the floor 22, the front wall 26 and one of the panels 16; and another sub-compartment 20 defined by the floor 22, the tailgate 28 and one of the panels 16. A second panel 16 can be inserted into one or more of the vertical slots 30 on top of any one or more of the panels 16 shown in FIG. 2 to increase the wall height of any of the sub-compartments 20 (as shown in FIG. 4). Additionally or alternatively, one or more panels 16 can be inserted into the lower horizontal slots 32 to create a two-tiered system of sub-compartments 20 (i.e., one or more lower sub-compartments 20 defined by the floor 22 and one or more upper sub-compartments 20 spaced apart from the floor 22), as shown in FIG. 3. Additionally or alternatively, one or more panels 16 can be inserted into the upper horizontal slots 33 to create a lid or cap for any one or more sub-compartments 20 (as shown in FIGS. 3 and 8). As shown in FIG. 7, a sufficient number of panels 16 can be inserted into the upper horizontal slots 33 to create a tonneau cover extending from the front wall 26 to the tailgate 28 and covering the entire cargo compartment 14.

The user can store any panels 16 that are not currently in use to define a sub-compartment 20 in the storage slots 36. FIG. 9 depicts six panels 16 all received in the storage slots 36 near the front wall 26 of the cargo compartment 14. The panels 16 can be stacked one atop another in the storage slots 36, and the panels 16 can be sandwiched against each other (i.e., with one of the faces 44 of each panel 16 abutting against another face 44 of at least one other panel 16). In this manner, a large number of panels 16 can be stored in a relatively small space disposed near the front wall 26 so as to occupy less space in the cargo compartment 14 while being readily deployable to create sub-compartments 20 on demand. As described above, in other embodiments, the storage slots 36 may be sized to receive any number of panels 16 and/or additional storage slots 36 can be provided.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and ail such modifications are intended to be included within the scope of the disclosure.

What is claimed is:

1. A vehicle comprising:
an occupant cabin;
a cargo compartment separated from the occupant cabin and including a floor and a pair of sidewalls extending vertically upward from the floor and extending between the occupant cabin and an aft end of the vehicle, the sidewalls being parallel to each other and including a plurality of vertically extending slots and a plurality of horizontally extending slots; and
a plurality of panels configured to be received in any of the vertically and horizontally extending slots and define one or more sub-compartments within the cargo compartment.

2. The vehicle of claim 1, wherein all of the panels are identical to each other.

3. The vehicle of claim 2, wherein each of the panels includes a first edge having a tab extending therefrom and a second edge having a groove formed therein such that the tab of one of the panels can engage the groove of a directly adjacent panel to removably fix the panels relative to each other.

4. The vehicle of claim 2, wherein a length of each panel is sized such that a single panel extends from one of the sidewalls to another sidewall.

5. The vehicle of claim 4, wherein a width of each panel is sized such that each vertical slot can receive two panels stacked one atop another.

6. The vehicle of claim 5, wherein each of the sidewalls include a pair of the horizontally extending slots, the horizontally extending slots are spaced apart from each other and parallel to each other and the floor such that one or more panels received in one of the horizontally extending slots of each sidewall defines a lower sub-compartment defined by the floor and an upper sub-compartment spaced apart from the floor.

7. The vehicle of claim 1, wherein each sidewall includes a storage slot disposed between the occupant cabin and the vertically extending slot closest to the occupant cabin.

8. The vehicle of claim 7, wherein the storage slot extends parallel to the vertically extending slots and has a width greater than or equal to the thickness of at least two of the panels stacked against each other.

9. The vehicle of claim 8, wherein the storage slot has a height greater than or equal to a height of two panels stacked on atop another.

10. The vehicle of claim 9, wherein the storage slot in one sidewall is aligned with the storage slot in another sidewall so that at least four of the panels can be simultaneously received in the storage slots of both sidewalls.

11. The vehicle of claim 1, wherein an upper one of horizontal slots in each sidewall is disposed proximate an upper edge of the sidewall such that the upper horizontal slots are configured to receive some of the panels in a manner that the panels cooperate to form a tonneau cover.

12. A vehicle comprising:
an occupant cabin;
a cargo compartment separated from the occupant cabin and including a floor, a pair of sidewalls and a tailgate, the sidewalls extending vertically upward from the floor and extending between the occupant cabin and the tailgate, the sidewalls being parallel to each other and each including a plurality of vertically extending slots and a horizontally extending slot; and
a plurality of panels that are all identical to each other and are configured to be received in any of the vertically and horizontally extending slots and define one or more sub-compartments within the cargo compartment.

13. The vehicle of claim 12, wherein each of the panels includes a first edge having a tab extending therefrom and a second edge having a groove formed therein such that the tab of one of the panels can engage the groove of a directly adjacent panel to removably fix the panels relative to each other.

14. The vehicle of claim 12, wherein a length of each panel is sized such that a single panel extends from one of the sidewalls to another sidewall.

15. The vehicle of claim 14, wherein a width of each panel is sized such that each vertical slot can receive two panels stacked one atop another.

16. The vehicle of claim 15, wherein each of the sidewalls include a pair of the horizontally extending slots, the horizontally extending slots are spaced apart from each other and parallel to each other and the floor such that one or more panels received in one of the horizontally extending slots of each sidewall defines a lower sub-compartment defined by the floor and an upper sub-compartment spaced apart from the floor.

17. The vehicle of claim 12, wherein each sidewall includes a storage slot disposed between the occupant cabin and the vertically extending slot closest to the occupant cabin.

18. The vehicle of claim 17, wherein the storage slot extends parallel to the vertically extending slots and has a width greater than or equal to the thickness of at least two of the panels stacked against each other.

19. The vehicle of claim 18, wherein the storage slot has a height greater than or equal to a height of two panels stacked on atop another.

20. The vehicle of claim 19, wherein the storage slot in one sidewall is aligned with the storage slot in another sidewall so that at least four of the panels can be simultaneously received in the storage slots of both sidewalls.
